(19) United States
(12) Patent Application Publication
(10) Pub. No.: US 2025/0258725 A1
(43) Pub. Date: Aug. 14, 2025

(54) CONTROL PATH COMMUNICATION BETWEEN NON-HOST PROCESSING DEVICES

(71) Applicant: Hewlett Packard Enterprise Development LP, Spring, TX (US)

(72) Inventors: Sai Rahul Chalamalasetti, Milpitas, CA (US); Kaiwen Cao, Urbana, IL (US); Aditya Dhakal, Santa Clarita, CA (US); Dejan S. Milojicic, Palo Alto, CA (US); Russ W. Herrell, Fort Collins, CO (US)

(21) Appl. No.: 18/440,758

(22) Filed: Feb. 13, 2024

(51) Int. Cl. G06F 9/54

(52) U.S. Cl. CPC G06F 9/544

(57) ABSTRACT

In certain embodiments, a computer-implemented method includes receiving, by a first non-host processing device from a host processing device, configuration information for configuring the first non-host processing device. The method includes receiving, by the first non-host processing device, computer code; receiving, by the first non-host processing device, a first trigger to execute a portion of the computer code; and executing, in response to the first trigger, the portion of the computer code. The method includes writing, by the first non-host processing device and based at least in part on the execution of the portion of the computer code, data to a destination buffer of a second non-host processing device; and sending, by the first non-host processing device and in response to writing the data to the destination buffer, a second trigger to the second non-host processing device to cause the second non-host processing device to execute second computer code.

### BACKGROUND

In some computing environments, to more efficiently execute tasks, a host processing device may offload or otherwise assign certain tasks to one or more non-host processing devices for execution. Examples of non-host processing devices may include accelerators, smart storage devices, or other types of non-host processing devices capable of executing tasks. Particular example devices may include graphics processing unit (GPU) devices, application-specific integrated circuit (ASIC) devices, field-programmable gate array (FPGA) devices, and vision processing unit (VPU) devices, and/or other types of hardware devices. Particular example smart storage devices may include a flash storage device with a locally coupled processor (e.g., an ASIC, FPGA, or other type of processing device). Although potentially used for any of a variety of purposes, these hardware accelerators or other non-host processing devices may be used to accelerate execution of computationally-intensive algorithms, such as machine learning algorithms or genome sequence alignment algorithms.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates an example computer system for control path communication between non-host processing devices, according to certain embodiments;

FIG. 2 illustrates additional details of an example non-host processing device for control path communication between non-host processing devices, according to certain embodiments;

FIG. 3 illustrates an example method for control path communication between non-host processing devices, according to certain embodiments;

FIG. 4 illustrates an example method for control path communication between non-host processing devices, according to certain embodiments;

FIG. 5 illustrates an example signaling flow for accelerator-to-accelerator control path signaling, according to certain embodiments;

FIG. 6 illustrates an example signaling flow for accelerator-to-accelerator with compute-capable storage control path signaling, according to certain embodiments;

FIG. 7 illustrates an example computing environment in which certain embodiments of this disclosure may be implemented;

FIGS. 8A-8C illustrate various levels of an example computing environment in which aspects of this disclosure may be implemented, according to certain embodiments; and

FIG. 9 illustrates a block diagram of an example computing device, according to certain embodiments.

### DETAILED DESCRIPTION

During execution of tasks assigned by a host processing device, it may be appropriate for one or more non-host processing devices to share data or other information related to the execution of those tasks. For example, accelerator-based communication typically relies on the host-based handshaking to initiate execution of kernel and data-communication from accelerator to accelerator or accelerator to storage. In other words, accelerator-based communication typically uses a host-centric control path. With a host-centric control path flow, the number of accelerators and storage nodes might not scale independently of the number of hosts, and the efficiency and scalability of compute paradigms based on disaggregated resources may be limited, potentially significantly.

Certain embodiments of this disclosure propose a solution that allows these non-host processing devices to communicate directly with each other, in a peer-to-peer manner, in a control path as part of an execution flow, with reduced interaction in the control path with the host processing device. In other words, certain embodiments reduce or eliminate involvement of the host processing device in the control path for data transfers from one non-host processing device to another non-host processing device.

The control path communications may be implemented as triggers that are communicated between non-host processing devices to notify each other when to begin processing, and potentially indicating that the non-host processing device that sent the trigger transferred data to the non-host processing device that received the trigger. These triggers may be implemented in various ways. For example, the triggers may be implemented as triggered operations, interrupts, or other mechanisms.

The control path communications (e.g., the triggers) may be sent directly between non-host processing devices (e.g., without traversing the host processing device) using any suitable communication protocol. In one example, Compute Express Link (CXL) 3.0 and CXL 3.1 provide a mechanism for peer-to-peer communications that non-host processing devices may use to communicate directly with one another without those communications traversing the host processing device. As another example, a software overlay may be provided for an interconnect interface (e.g., peripheral component interconnect express (PCIe) to implement a mechanism for peer-to-peer communications that non-host processing devices may use to communicate directly with one another without those communications traversing the host processing device. With certain interconnect technologies, such as CXL 3.0 and 3.1, accelerators and storage can be distributed across different sections of a data center, both inter-rack and intra-rack.

Certain embodiments of this application provide a non-host-based control path, controlled by accelerator or storage, that may improve communication performance and/or latency, and that may improve quality of service (QOS) for application execution. A communication scheme that reduces control path communications through the host processing device may reduce a burden on the host processing device, potentially freeing host processing device processing resources for other tasks for which the host processing device is responsible. Due to the communication control path built into the accelerator or storage kernel/controller, a need for an explicit memory copy in a host might be reduced or eliminated, potentially providing easier programmability. Certain embodiments may reduce or eliminate choke blocks for scalability. Certain embodiments may provide improved system resilience. Certain embodiments may improve system reliability and availability, as state may be less distributed (e.g., relative to host-centric techniques), which may reduce dependency in case of device failure, and less components with which to interact, potentially leading to the aforementioned increased scalability. Certain embodiments may be accelerator/storage vendor-agnostic, providing easier programming with many accelerators and storage modules. Although usable in any of a variety of contexts, from simple computer system setups to complex computing environments, certain embodiments may be useful for large algorithm processing scenarios, such as neural networks, machine learning (ML) training, and large language model algorithms as particular examples.

This disclosure refers to host processing devices and non-host processing devices. In certain embodiments, a host processing device may include a processing device that runs a host operating system (OS) and may assign processing tasks to non-host processing devices to implement parallel or other distributed processing of program execution tasks associated with execution flows. For example, as part of executing an application, a host processing device may implement distributed (and possibly parallel) processing of the application by assigning one or more processes to one or more non-host processing devices for execution of one or more execution flows. The one or more non-host processing devices may work together to complete one or more execution flows. In certain embodiments, the host processing device is or includes one or more central processing units (CPUs). In certain embodiments, the host processing device may be considered a primary device while the non-host processing devices may be considered secondary devices.

A non-host processing device may include some input/output (I/O) capabilities or related software prompted by host processing device actions. For example, a non-host processing device may be capable of executing processing tasks in response to instructions from a host processing device, potentially as part of the host processing device offloading such processing tasks. Example non-host processing devices include accelerators, compute-capable storage devices (e.g., so-called smart storage devices), compute-capable network interface controllers (NICs) (e.g., so-called smart NICs), or other types of non-host processing devices capable of executing tasks. Particular example non-host processing devices may include GPU devices, ASIC devices, FPGA devices, VPU devices, and/or other types of hardware devices, some of which may overlap in type. Particular example smart storage devices may include a flash storage device or a fabric-attached memory (FAM) with a locally coupled processor (e.g., an ASIC, FPGA, or other type of processing device). It should be understood that this disclosure contemplates non-host processing devices including one or more CPUs, such as may be the case with a compute-capable storage device, a compute-capable NIC, or other suitable non-host processing device, for example.

As just one particular example in the context of CXL (e.g., CXL 3.0 or 3.1), a host processing device may source a CXL root port and may be the top of a CXL/PCIe virtual hierarchy, and the one or more non-host processing devices may be attached to a downstream port of a CXL/PCIe switch or directly to a CXL root port of a host processing device. It should be understood that host processing devices and associated non-host processing devices may be implemented in other manners, including in different contexts from CXL.

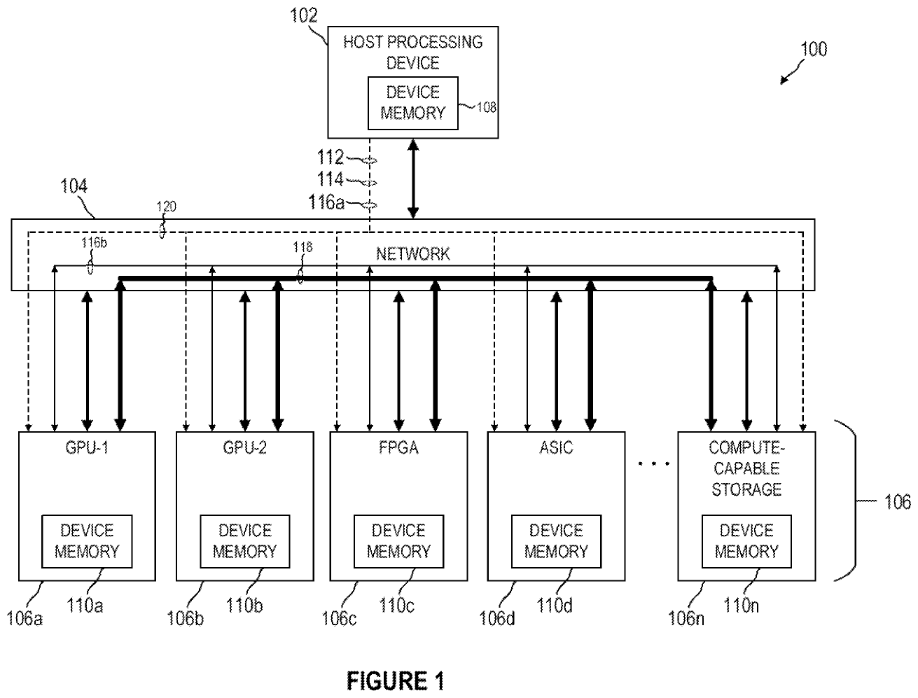

Turning to the figures, FIG. 1 illustrates an example computer system 100 for control path communication between non-host processing devices, according to certain embodiments. Although a particular implementation of computer system 100 is illustrated and described, this disclosure contemplates any suitable implementation of computer system 100.

Computer system 100 could be a standalone computer or part of a larger computing environment. Computer system 100 could be, or be part of, a local computing environment (e.g., a private computing environment), a cloud computing environment (e.g., a public computing environment), a hybrid computing environment (e.g., a private computing environment and a public computing environment), or another suitable type of computing environment.

In the illustrated example, computer system 100 includes a host processing device 102, a communication network 104, and non-host processing devices 106. Although computer system 100 is illustrated as including these particular components, computer system 100 may include fewer, additional, and/or different components, as may be appropriate for a given implementation.

Host processing device 102 may be a general purpose processor capable of generic computation. Host processing device 102 may have one or more cores. Host processing device 102 may maintain primary responsibility for managing processing tasks of computer system 100. Although computer system 100 is illustrated as including a single host processing device 102, computer system 100 could include multiple host processing devices 102, if appropriate.

Host processing device 102 includes device memory 108. Device memory 108 may be any suitable type or combination of types of storage, including, for example, any suitable combination of volatile memory, non-volatile memory, and/or virtualizations thereof. For example memory may include any suitable combination of magnetic media, optical media, random access memory (RAM), read-only memory (ROM), removable media, and/or any other suitable memory component. Device memory 108 may include data structures used to organize and store all or a portion of the stored data. In general, device memory 108 can store any data used by or accessible to host processing device 102.

Non-host processing devices 106 may include any suitable processing devices that may perform one or more processing tasks. Some or all of the processing tasks performed by non-host processing devices 106 may be coordinated, at least in part, by host processing device 102. Non-host processing devices 106 may include one or more accelerators, compute-capable storage devices, compute-capable NICs, and/or other suitable types of non-host processing devices in any suitable combination.

Particular example accelerators may include GPU devices, ASIC devices, FPGA devices, and VPU devices, and/or other types of hardware devices. Particular example compute-capable storage devices, which may be referred to as smart storage devices, may include a flash storage device (e.g., potentially including an array of coupled flash storage devices) with a locally coupled processor (e.g., an ASIC, FPGA, or other type of processing device). Some compute-capable storage devices are referred to as computational storage devices.

In the illustrated example, non-host processing devices 106 include non-host processing device 106a, non-host processing device 106b, non-host processing device 106c, non-host processing device 106d, and through non-host processing device 106n, with n being a positive integer greater than four. Although illustrated as including a certain number of non-host processing devices 106, computer system 100 may include two or more non-host processing devices 106.

In the illustrated example, non-host processing device 106a is a first GPU (e.g., GPU-1), non-host processing device 106b is a second GPU (e.g., GPU-2), non-host processing device 106c is an FPGA, non-host processing device 106d is an ASIC, and non-host processing device 106n is compute-capable storage. Although this particular combination of types of non-host processing devices 106 is illustrated, computer system 100 may include any suitable types of non-host processing devices 106 in any suitable combination.

Each of non-host processing devices 106 includes corresponding device memory 110. Device memory 110 may be any suitable type or combination of types of storage, including, for example, device memory 110 may be any suitable type or combination of types of storage, including, for example, any suitable combination of volatile memory, non-volatile memory, and/or virtualizations thereof. For example memory may include any suitable combination of magnetic media, optical media, RAM, ROM, removable media, and/or any other suitable memory component. Device memory 110 may include data structures used to organize and store all or a portion of the stored data. In general, device memory 110 can store any data used by or accessible to the corresponding non-host processing device 106.

Host processing device 102 and non-host processing devices 106 may communicate with each other via communication network 104. Non-host processing devices 106 may communicate with one another via communication network 104. Communication network 104 facilitates wireless and/or or wireline communication. Communication network 104 may communicate, for example, IP packets, Frame Relay frames, ATM cells, voice, video, data, and other suitable information between network addresses. Communication network 104 may include any suitable combination of one or more local area networks (LANs), radio access networks (RANs), metropolitan area networks (MANs), wide area networks (WANs), mobile networks (e.g., using WiMax (802.16), WiFi (802.11), 3G, 4G, 5G (and beyond), or any other suitable wireless technologies in any suitable combination), all or a portion of the global computer network known as the Internet, and/or any other communication system or systems at one or more locations, any of which may be any suitable combination of wireless and wireline. In certain embodiments, at least a portion of communication network 104 is a high speed interconnect, such as one or more INFINIBAND network or a COMPUTE EXPRESS LINK (CXL) network.

Host processing device 102 may offload or otherwise assign one or more processing tasks to non-host processing devices 106. Host processing device 102 may offload or otherwise assign these processing tasks to non-host processing devices 106 as execution flows that involve non-host processing devices 106 executing computer code, potentially in sections. Some assigned execution flows may involve multiple non-host processing devices 106 and potentially an exchange of data by the non-host processing devices 106. In other words, to the extent host processing device 102 involves multiple non-host processing devices 106 to perform the one or more processing tasks, those multiple non-host processing devices 106 may share data with one another, and progression through the assigned processing tasks may include waiting for data from another non-host processing device 106. To that end, one or more of non-host processing devices 106 may have components called data movers that move and/or copy data for access by another non-host processing device 106, though this disclosure contemplates implementing the data sharing operation in any suitable manner.

To coordinate and initiate processing of one or more execution flows by multiple non-host processing devices 106, host processing device 102 may send configuration information 112 to two or more non-host processing devices 106. For example, host processing device 102 may send configuration information 112 for an execution flow to the two or more non-host processing devices 106 that will be involved in the execution flow. The configuration information may configure two or more non-host processing devices 106 to execute the one or more execution flows.

The configuration information may include an assignment of one or more source memory buffers and one or more destination memory buffers for the non-host processing devices 106. For example, for the non-host processing devices 106 that are to be involved in a particular execution flow, host processing device 102 may communicate configuration information 112 to those non-host processing devices 106 that includes allocations of source memory buffers and destination memory buffers in the respective device memory 110 of those non-host processing devices 106. In certain embodiments, the non-host processing devices 106 may use shared memory for the exchange of data during an execution flow. The source and destination buffers may be used, at least in part, for the exchange of data between two or more of the non-host processing devices 106 during the execution flow. In certain embodiments, configuration information 112 may include a termination condition for one or more of the non-host processing device 106 to terminate the execution flow.

As a particular example of allocating a source buffer and/or a destination buffer, configuration information 112 may indicate an amount of allocated memory in the device memory 110, a starting address, and/or an offset. For example, for a source buffer of non-host processing device 106a, configuration information 112 may indicate an allocation and assignment of 128 megabytes (MB) of memory in device storage 110a starting at address X with an offset of Y covering the whole 128 MB. Allocation and assignment of a destination buffer for non-host processing device 106a may operate in a similar manner, along with allocations and assignments of source and destination buffers of other non-host processing devices 106.

To configure two or more non-host processing devices 106 for an execution flow, host processing device 102 may send computer code 114 to the two or more non-host processing devices 106 that are to be involved in the execution flow. This computer code 114 may include instructions that define the functionality the non-host processing devices 106 are to perform as part of the execution flow. In certain embodiments, computer code 114 could be considered part of configuration information 112.

To start initial execution of the execution flow, host processing device 102 may send a trigger 116a to one or more non-host processing devices 106. For example, if one non-host processing device 106 is to start the execution flow, host processing device 102 may send a trigger 116a to that non-host processing device 106. If multiple non-host processing devices 106 are to begin executing in parallel for the execution flow, host processing device 102 may send respective triggers 116a to each of the multiple non-host processing devices 106 so that those non-host processing devices 106 begin executing respective portions of computer code 114 in parallel.

During processing of execution flows assigned by host processing device 102 to non-host processing devices 106, non-host processing devices 106 may process data stored in device memory 110 and communicate processed data 118 along data paths (shown using relatively thick lines in FIG. 1) to other non-host processing devices 106. As a result, a particular non-host processing device 106 might be in a state in which the non-host processing device 106 is processing data 118 through executing a portion of computer code 114. In such a state, one or more other non-host processing devices 106 may be waiting on data from the particular non-host processing device 106. At other times, the particular non-host processing device 106 may be in a state in which the particular non-host processing device 106 is waiting on data 118 from one or more other non-host processing devices 106 before the particular non-host processing device 106 executes a portion of computer code 114.

Through a control path, non-host processing devices 106 may exchange messages to notify other non-host processing devices 106 when data has been written to their respective destination buffers and is ready for processing or to otherwise prompt those other non-host processing devices 106 to execute some portion of computer code 114, if appropriate. In some systems, the control path for control path communications passes through host processing device 102 such that non-host processing devices 106 notify host processing device 102 when a stage of computer code processing is complete and data has been written to a destination buffer of one or more other non-host processing devices 106 and is ready for those other non-host processing devices 106 to process the data. This type of control path potentially introduces delay in the execution flow and wastes resources of host processing device 102.

Throughout this process of processing execution flows assigned by host processing device 102, certain embodiments of this disclosure may reduce control path communications between non-host processing devices 106 and host processing device 102. For example, in a control path (shown using relatively thin lines in FIG. 1), non-host processing devices 106 may communicate triggers 116b to one another upon completion of execution of a code segment, writing of data to a destination buffer of another non-host processing device 106 to trigger execution of a next code segment by the recipient non-host processing device 106, and/or writing of data to a source buffer of the non-host processing device 106 (e.g., that is to communicate a trigger 116b) to trigger execution of a code segment potentially to retrieve the data by the non-host processing device 106 that receives the trigger 116b. These triggers 116b may be communicated directly between non-host processing devices 106, bypassing host processing device 102 (e.g., without being sent to host processing device 102), in a peer-to-peer manner. These triggers 116b may be part of the control path communications between non-host processing devices 106, as the triggers 116b control execution flow by non-host processing devices 106 of the computer code 114. Data exchange between non-host processing devices 106 may be considered a separate path-data path communications (again, shown using relatively thick lines in FIG. 1).

Triggers 116 refers generally to triggers 116a, which are sent by host processing device 102 to non-host processing devices 106, and triggers 116b, which are sent directly (e.g., via communication network 104) between non-host processing devices 106 in a peer-to-peer manner without being sent via host processing device 102. Triggers 116 provide a way to control flow of operations. For example, triggers 116b may control a flow of operations in the execution thread rather than in the coordination thread managed by host processing device 102.

The triggering mechanisms for sending and receiving triggers 116 may be implemented using any suitable combination of hardware, firmware, and software. In certain implementations, triggers 116b can provide the ability for the system to set up operations that can asynchronously trigger with the completion of other operations without the involvement of software, though this disclosure contemplates implementing triggers 116 using software, if appropriate. Triggers 116 may be configured in any of a variety of ways. In certain embodiments, a trigger 116 may be implemented as a message in the form of an interrupt-type message, a triggered operation (e.g., a Write message to a triggering location), or a combination of the two. That is, the triggering mechanism may be configured as an interrupt, a triggered operation, or another suitable type of triggering mechanism.

In an interrupt implementation of the triggering mechanism, when a non-host processing device 106 receives a trigger 116, the trigger 116 may serve as or otherwise result in creation of an interrupt on a thread that is executing at the non-host processing device 106 that receives the trigger 116. In a triggered operation implementation of the triggering mechanism, a non-host processing device 106 may have a trigger mechanism that, when triggered (e.g., by receipt of a trigger 116) causes certain code to be executed. The code could cause the non-host processing device 106 that received the trigger 116 to obtain data from another non-host processing device 106 (e.g., the non-host processing device that sent the trigger 116), for example. The non-host processing device 106 that sent the trigger 116 may be programmed to issue the trigger 116 upon completion of some action or set of actions (e.g., writing data to memory after performing certain processing). Triggered operations may be an example of hardware data processing. In certain embodiments, the triggering mechanism may be implemented as so-called doorbells.

The triggering mechanism may be set up as part of configuration information 112 non-host processing devices 106 receive from host processing device 102, though the triggering mechanism may be set up in any suitable manner. In the doorbell example, host processing device 102 (e.g., for triggers 116a) or non-host processing devices 106 (e.g., for triggers 116b) may write to or otherwise “ring” a doorbell of another non-host processing device 106 to notify the other non-host processing device 106 that data 118 has been written to a destination buffer of the other non-host processing device 106 and/or to prompt the other non-host processing device 106 to execute a portion of computer code 114. Non-host processing device 106 may be configured to check whether a doorbell of the non-host processing device 106 has been set, and clear the doorbell in response to confirming the doorbell has been set. The setting of a doorbell could signify availability of data. Although referred to as a doorbell, this triggering mechanism could be implemented as any suitable type of triggered operation, interrupt, or other triggering mechanism.

In certain embodiments, multiple triggers 116 may be configured for a non-host processing device 106 for triggering code execution over the course of an execution flow. For example, a first trigger could be an initial trigger 116 that operates to trigger the initial start of code execution and additional triggers 116 could be configured for respective additional stages of code execution over the course of the execution flow.

In certain embodiments, the particular points in an execution flow when a non-host processing device 106 is to send a trigger 116b to another non-host processing device 106 or may expect to receive a trigger 116b from one or more other non-host processing devices 106 may be defined in configuration information 112, computer code 114, or another suitable location, or may be specified in another suitable manner. In certain embodiments, a non-host processing device 106 may be programmed to wait for more than one trigger 116 (e.g., multiple triggers 116b) before executing a next portion of computer code 114. This situation could arise, for example, if the code a particular non-host processing device 106 is waiting to execute depends on data 118 received from multiple other particular non-host processing devices 106. In this example, each of the other particular non-host processing devices 106 may send respective triggers 116b to the particular non-host processing device 106, indicating that those other particular non-host processing devices 106 have made data 118 available to the particular non-host processing device 106, such as in a destination buffer in device memory 110 of the particular non-host processing device 106). The particular non-host processing device 106 may wait for the multiple respective triggers 116b to be received before executing the computer code 114 to process the received data 118.

Triggers 116 can be formatted as any suitable type of message that can be sent in a peer-to-peer manner from one non-host processing device 106 to at least one other non-host processing device, without being required to traverse host processing device 102. In certain embodiments, triggers 116 may be stored in message buffers on non-host processing devices 106 such that one non-host processing device 106 may write a message (e.g., a trigger 116) to the message buffer of another non-host processing device 106. The particular protocol used for sending triggers 116 may depend on the fabric of communication network 104. For example, triggers 116 could be formatted as CXL messages, message passing protocol (MPI) messages, Symmetric Hierarchical MEMory (SHMEM) messages, NVIDIA NVLink messages, PCIe messages, and or other possible message formats, some of which may overlap in type. In certain embodiments of triggers 116, the receipt of a trigger 116 is directly linked to the executing of a particular block of code with little or no intervention of a general message receive stack, like TCP/IP or completion queue handlers. Triggers 116 may include an identifier of a process that communicated the trigger 116, which may be used by the receiving non-host processing device 106 to confirm receipt of triggers 116 from one or more expected non-host processing devices 106.

In certain embodiments, the CXL 3.0 and CXL 3.1 framework provide a peer-to-peer communication capability that non-host processing devices 106 can use to communicate directly with one another, bypassing host processing device 102, in a peer-to-peer fashion. It should be understood, however, that this disclosure is not limited to embodiments in which communication network 104 implements, and non-host processing devices 106 are configured for, CXL 3.0 and/or CXL 3.1 communications. This disclosure contemplates using any suitable technique for non-host processing devices 106 to communicate directly with one another in a peer-to-peer fashion, bypassing host processing device 102. As just one example, a software overlay in a PCIe-based fabric of communication network 104 could be used.

Although certain embodiments reduce a number of times non-host processing devices 106 communicate in a control path with host processing device 102, it still may be appropriate for non-host processing devices 106 to report to host processing device 102 from time to time, shown as messages 120. For example, a non-host processing device 106 may communicate a message 120 to host processing device 102 upon completion of an entire execution flow (e.g., after detection of a termination condition) or at other suitable times.

In operation of an example embodiment of computer system 100 from the perspective of non-host processing device 106a, non-host processing device 106a of computer system 100 may receive from host processing device 102 of computer system 100, configuration information 112 for configuring non-host processing device 106a to execute a first execution flow. In certain embodiments, the configuration information 112 includes an assignment of a source memory buffer and a destination memory buffer for non-host processing device 106a to which data 118 for non-host processing device 106a may be written and from which data 118 from non-host processing device 106a may be sent, respectively. In certain embodiments, the configuration information 112 may include a termination condition for non-host processing device 106b to terminate the first execution flow. Non-host processing device 106a may receive first computer code 114 for execution by non-host processing device 106a.

Non-host processing device 106a may receive a first trigger 116 to execute at least a portion of first computer code 114. In certain embodiments, the portion of the first computer code 114 is an initial portion of the first computer code 114, and the first trigger 116 is a first trigger 116a received by non-host processing device 106a from host processing device 102. In certain embodiments, the first trigger 116 is a first trigger 116b received by non-host processing device 106a from another non-host processing device (e.g., non-host processing device 106b).

In response to the first trigger 116, non-host processing device 106a may execute the portion of the first computer code 114. In certain embodiments, non-host processing device 106a is configured to receive multiple triggers 116 from one or more other non-host processing devices 106 prior to executing the portion of the first computer code 114. In such an example, non-host processing device 106a may receive the multiple triggers 116b from the one or more other non-host processing devices 106, and may execute, in response to the triggers 116b from the one or more other non-host processing devices 106, the first portion of the first computer code 114.

Based at least in part on the execution of the portion of the first computer code 114, non-host processing device 106a may write first data 118 to a destination buffer of non-host processing device 106b. In response to writing the first data 118 to the destination buffer of non-host processing device 106b, non-host processing device 106a may send a second trigger 116b to non-host processing device 106b to cause non-host processing device 106b to execute second computer code 114.

Non-host processing device 106a may receive a third trigger 116b from another non-host processing device 106, which may have written second data 118 to a destination buffer of non-host processing device 106a. For example, non-host processing device 106a may receive the third trigger 116b from non-host processing device 106b (e.g., the same non-host processing device 106 from which the first trigger 116b was received if the first trigger 116b was received from a non-host processing device 106) or from another non-host processing device (e.g., non-host processing device 106c).

In response to the third trigger 116b, non-host processing device 106a may execute a second portion of the first computer code 114. In certain embodiments, non-host processing device 106a is configured to receive multiple triggers 116b from one or more other non-host processing devices 106 prior to executing the second portion of the first computer code 114. In such an example, non-host processing device 106a may receive the multiple triggers 116b from the one or more other non-host processing devices 106, and may execute, in response to the triggers 116b from the one or more other non-host processing devices 106, the second portion of the first computer code 114.

This process may terminate according to a termination condition indicated in configuration information 112 for non-host processing device 106a or another non-host processing device 106. Additionally or alternatively, non-host processing device 106a may receive an interrupt from host processing device 102 to cause non-host processing device 106a to terminate the first execution flow. This disclosure contemplates the process terminating in any suitable manner.

In operation of an example embodiment of computer system 100 from the perspective of non-host processing device 106a, non-host processing device 106a may receive from host processing device 102 configuration information 112 for configuring non-host processing device 106a to execute a first execution flow. In certain embodiments, configuration information 112 includes an assignment of a source memory buffer and a destination memory buffer for non-host processing device 106a to which data 118 for non-host processing device 106a may be written and from which data from non-host processing device 106a may be sent, respectively. In certain embodiments, configuration information 112 may include a termination condition for non-host processing device 106b to terminate the first execution flow. Non-host processing device 106a may receive first computer code 114 for execution by non-host processing device 106a.

Non-host processing device 106a may receive a first trigger 116 to execute at least a portion of first computer code 114. In certain embodiments, the portion of the first computer code 114 is an initial portion of the first computer code 114, and the first trigger 116 is a first trigger 116a received by non-host processing device 106a from host processing device 102. In certain embodiments, the first trigger 116 is a first trigger 116b received by non-host processing device 106a from another non-host processing device (e.g., non-host processing device 106b).

Non-host processing device 106a may determine whether receipt of additional triggers 116 is expected prior to executing a next portion of first computer code 114. In certain embodiments, non-host processing device 106a is configured to receive multiple triggers 116 from one or more other non-host processing devices 106 prior to executing the first portion of the first computer code 114. In such an example, non-host processing device 106a may receive the multiple triggers 116b from one or more other non-host processing devices 106, and may execute, in response to the triggers 116b from the one or more other non-host processing devices 106, the first portion of the first computer code 114.

If non-host processing device 106a determines that receipt of additional triggers 116 is expected, non-host processing device 106a may await additional triggers. If non-host processing device 106a determines that receipt of additional triggers 116 is not expected (e.g., only one trigger 116 was expected and/or all expected triggers 116 have been received), then, in response to receiving the expected triggers 116, non-host processing device 106a may execute the first portion of the first computer code 114.

Based at least in part on the execution of the first portion of the first computer code 114, non-host processing device 106a may write first data 118 to respective destination buffers of one or more other non-host processing devices 106 (e.g., non-host processing device 106b). In response to writing the first data 118 to the respective destination buffers of one or more other non-host processing devices 106 (e.g., non-host processing device 106b), non-host processing device 106a may send respective second triggers 116b to the one or more other non-host processing devices 106 (e.g., to non-host processing device 106b) to cause the one or more other non-host processing devices 106 (e.g., non-host processing device 106b) to execute second computer code 114.

Non-host processing device 106a may determine whether a termination condition is detected. For example, this process may terminate according to a termination condition indicated in configuration information 112 for non-host processing device 106a or another non-host processing device 106. Additionally or alternatively, non-host processing device 106a may receive an interrupt from host processing device 102 to cause non-host processing device 106a to terminate the first execution flow. This disclosure contemplates the process terminating in any suitable manner.

If non-host processing device 106a determines that the termination condition has not been detected, then non-host processing device 106a may await additional triggers 116. If non-host processing device 106a determines that the termination condition has been detected, then the process may end, at least with respect to the first execution flow. Non-host processing device 106a could be engaged in one or more other execution flows that may remain ongoing.

Although this disclosure primarily describes implementations in which system 100 includes a host processing device 102, this disclosure contemplates implementations in which host processing device 102 is omitted and/or in which non-host processing devices 106 communicate directly with one another in a peer-to-peer manner without involving host processing device 102 at all. As a particular example, certain implementations may lack a host processing device 102 and include non-host processing devices 106 that communicate with one another in a manner consistent with this disclosure. In certain implementations, one or more of the non-host processing devices 106 may coordinate distribution of processing tasks among the non-host processing devices 106.

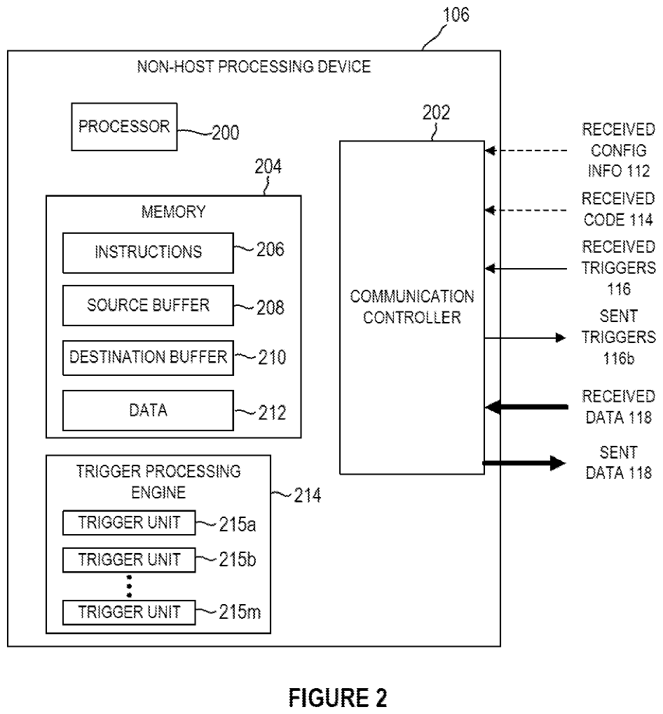

FIG. 2 illustrates additional details of an example non-host processing device 106 of FIG. 1 for control path communication between non-host processing devices 106, according to certain embodiments. Although a particular implementation of non-host processing device 106 is illustrated and described, this disclosure contemplates any suitable implementation of non-host processing device 106.

In the illustrated example non-host processing device 106 includes processor 200, communication controller 202, and memory 204. Although described in the singular for ease of description, non-host processing device 106 may include one or more processors 200, one or more communication controllers 202, and one or more memories 204.

Processor 200 may be any component or collection of components adapted to perform computations and/or other processing-related tasks. Processor 200 can be, for example, a microprocessor, a microcontroller, a control circuit, a digital signal processor, an FPGA, an ASIC, a system-on-chip (SoC), or combinations thereof. Processor 200 may include any suitable number of processors, or multiple processors may collectively form a single processor 200.

Communication controller 202 represents any suitable computer element that can receive information from a communication network (e.g., communication network 104 of FIG. 1), transmit information through a communication network (e.g., communication network 104 of FIG. 1), perform suitable processing of the information, communicate to other components (e.g., of computer system 100 of FIG. 1), or any combination of the preceding. Communication controller 202 represents any port or connection, real or virtual, including any suitable combination of hardware, firmware, and software, including protocol conversion and data processing capabilities, to communicate through a LAN, WAN, or other communication system that allows information to be exchanged with devices of computer system 100. Communication controller 202 may facilitate wireless and/or wired communication. In certain embodiments, at least a portion of communication network 104 is a high speed interconnect, such as one or more INFINIBAND network or a CXL network, and communication controller 202 is configured to facilitate communication over such high speed interconnects.

Communication controller 202 may facilitate the communication and/or receipt of configuration information (e.g., received configuration information 112 of FIG. 1), computer code (e.g., received computer code 114 of FIG. 1), received triggers (e.g., received triggers 116a/116b of FIG. 1), sent triggers (e.g., sent triggers 116b of FIG. 1), received data (e.g., received data 118 of FIG. 1), and/or sent data (e.g., sent data 118 of FIG. 1).

Memory 204 may include any suitable combination of volatile memory, non-volatile memory, and/or virtualizations thereof. For example memory may include any suitable combination of magnetic media, optical media, RAM, ROM, removable media, and/or any other suitable memory component. Memory 204 may include data structures used to organize and store all or a portion of the stored data. Device memory 110 of FIG. 1 could be part of or separate from memory 204.

In the illustrated example, memory 204 stores instructions 206, source buffer 208, destination buffer 210, and data 212. Instructions 206 may include the logic for managing operation of non-host processing device 106 in connection with executing workflows, including communicating with a host processing device (e.g., host processing device 102 of FIG. 1); processing configuration information (e.g., configuration information 112 of FIG. 1); executing computer code (e.g., computer code 114 of FIG. 1); interacting with source buffers 208 and destination buffers 210; processing data 212; communicating, receiving, and processing triggers 116 of FIG. 1 via communication with a host processing device (e.g., host processing device 102 of FIG. 1) or control path communication with other non-host processing devices (e.g., non-host processing devices 106 of FIG. 1).

At least a portion of memory 204 may be considered a computer-readable medium on which computer code (e.g., instructions 206) is stored. References to computer-readable medium, computer-readable storage medium, computer program product, tangibly embodied computer program, or the like, or a controller, circuitry, computer, processor, or the like should be understood to encompass not only computers having different architectures such as single or multi-processor architectures and sequential (Von Neumann) or parallel architectures but also specialized circuits such as FPGAs, ASICs, signal processing devices, and other devices. References to computer program, instructions, logic, code, or the like, should be understood to encompass software for a programmable processor or firmware such as, for example, the programmable content of a hardware device whether instructions for a processor, or configuration settings for a fixed-function device, gate array or programmable logic device, or the like.

Source buffer 208 may be allocated by a host processing device. For example, source buffer 208 may be allocated by host processing device 102 as part of configuration information 112 of FIG. 1. Source buffer 208 may be a set of memory locations of memory 204 that store data that non-host processing device 106 is to communicate to destination buffers of other non-host processing devices 106. Destination buffer 210 may be a set of memory locations of memory 204 available for writing with data received from other non-host processing devices 106. Data 212 may correspond to data 118 of FIG. 1. Data 212 could be stored permanently or temporarily in source buffer 208 (when sending) or destination buffer 210 (when receiving), but could also be stored permanently or temporarily in other locations of memory 204, if desired.

Non-host processing device 106 may include a trigger processing engine 214 that implements the triggering mechanism for non-host processing device 106 and which may be consistent with the triggering mechanism of system 100 of FIG. 1. Trigger processing engine 214 may be implemented using any suitable combination of hardware, firmware, and software. In an example, trigger processing engine 214 includes trigger processing circuitry for implementing the triggering mechanism of non-host processing node 106. Trigger processing engine 214 may include the mechanisms for processing triggers 116, including receiving triggers 116, sending triggers 116, and otherwise initiating execution of code (e.g., some portion of instructions 206) in response to receipt of a trigger 116. Although illustrated separately, trigger processing engine could be part of processor 200, part of communication controller 202, part of memory 204, separate from these components of non-host processing device 106, or a combination of the above.

Trigger processing engine 214 may include one or more trigger units 215 (shown as triggers 215a, 215b, through 215m), which may implement each trigger that non-host processing device 106 is configured to include. For example, each trigger unit 215 may correspond to a type of trigger 116 and to particular code (e.g., a portion of instructions 206) that is to be executed in response to activation of the trigger associated with that trigger unit 215 (e.g., in response to receipt of a trigger 116 that activates that trigger unit 215). Each trigger unit 215 may include any suitable combination of hardware (e.g., circuitry), firmware, and software. In certain embodiments, some or all of trigger units 215 implement one or more of an interrupt, a triggered operation, or another suitable type of trigger mechanism. In a particular example, one or more trigger units 215 could be implemented, in whole or in part, using a doorbell, a hardware state machine, or another suitable type of trigger mechanism.

In certain embodiments, trigger units 215 may be an area of memory 204, such as a message buffer, that stores triggers 116 received from a host processing device (triggers 116a of FIG. 1) and/or triggers received from other non-host processing devices 106 (e.g., triggers 116b of FIG. 1). For example, trigger units 215 may represent the storage locations of the so-called doorbells that may be written to/rung by other devices (e.g., host processing device 102 and/or non-host processing devices 106).

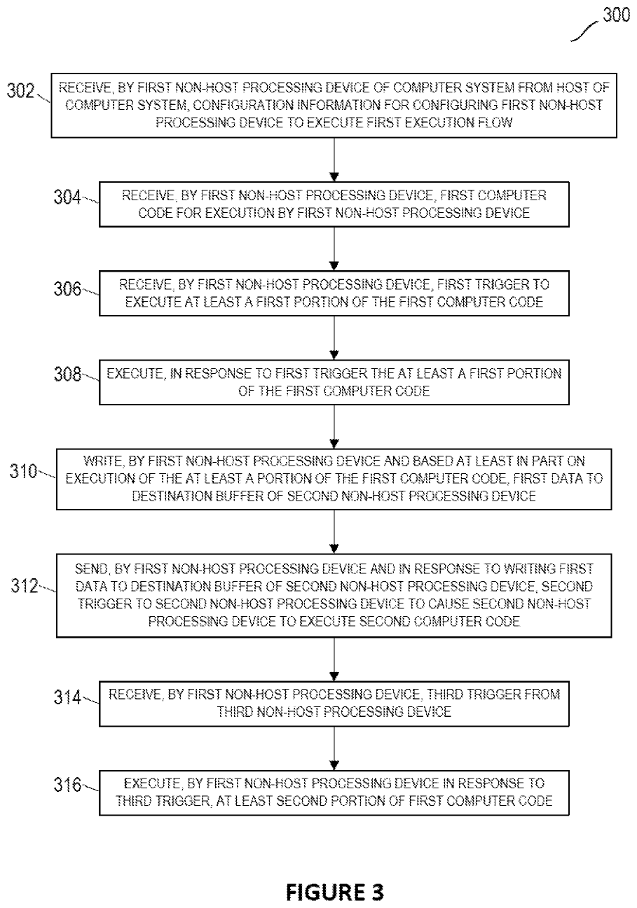

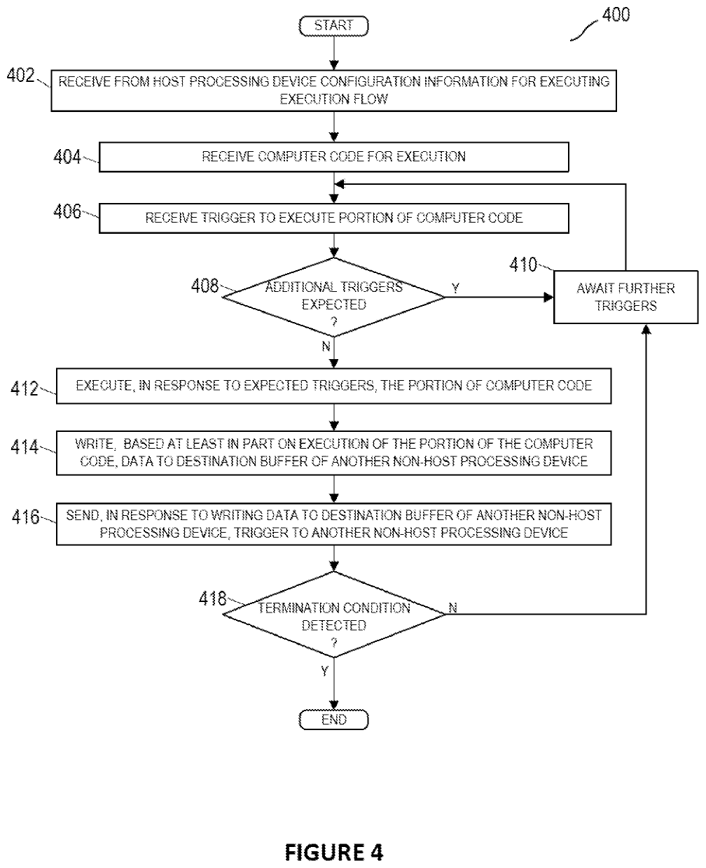

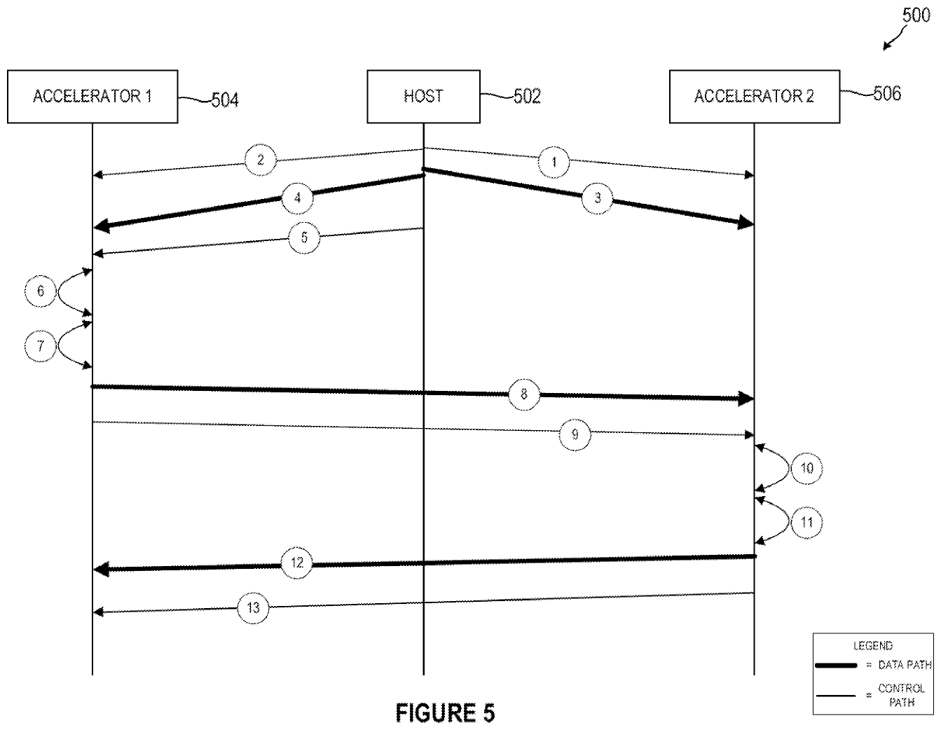

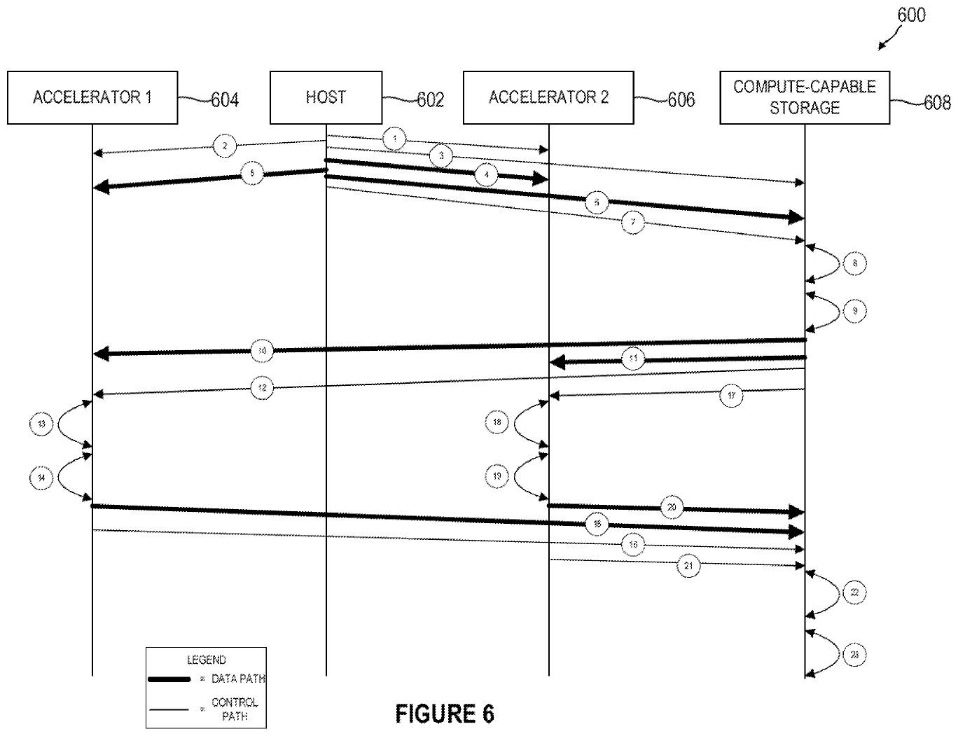

In operation of an example embodiment of non-host processing device 106, instructions 206 may execute processes in the manner described above in connection with FIG. 1 and below in connection with FIGS. 3-4 and portions of FIGS. 5-6. The descriptions of FIGS. 1, 3-4, and 5-6 are incorporated into the description of FIG. 2 by reference.

FIG. 3 illustrates an example method 300 for control path communication between non-host processing devices, according to certain embodiments. In certain embodiments, some or all of the operations associated with method 300 are performed by a first non-host processing device 106. For purposes of this example, a first non-host processing device is referred to as non-host processing device 106a, a second non-host processing device is referred to as non-host processing device 106b, and a third non-host processing device is referred to as non-host processing device 106c. One or more of the non-host processing devices 106 involved in method 300 could be an accelerator or a compute-capable storage device, in any suitable combination.

At step 302, non-host processing device 106a of computer system 100 receives from host processing device 102 of computer system 100, configuration information 112 for configuring non-host processing device 106a to execute a first execution flow. In certain embodiments, configuration information 112 includes an assignment of a source memory buffer and a destination memory buffer for non-host processing device 106a to which data 118 for non-host processing device 106a may be written and from which data 118 from non-host processing device 106a may be sent, respectively. In certain embodiments, configuration information 112 may include a termination condition for non-host processing device 106a to terminate the first execution flow.

At step 304, non-host processing device 106a may receive first computer code 114 for execution by non-host processing device 106a. At step 306, non-host processing device 106a may receive a first trigger 116 to execute at least a first portion of the first computer code 114. In certain embodiments, the at least a first portion of the first computer code 114 is an initial portion of the first computer code 114, and the first trigger 116 is received by non-host processing device 106a from host processing device 102 (e.g., trigger 116a). In certain embodiments, the first trigger 116 is received by non-host processing device 106a from another non-host processing device (e.g., second non-host processing device 106b, as trigger 116b).

At step 308, in response to the first trigger 116, non-host processing device 106a may execute the at least a first portion of the first computer code 114. In certain embodiments, non-host processing device 106a is configured to receive multiple triggers 116 from one or more other non-host processing devices 106 prior to executing the at least a first portion of the first computer code 114. In such an example, non-host processing device 106a may receive the multiple triggers 116 from the one or more other non-host processing devices 106, and may execute, in response to the multiple triggers 116 from the one or more other non-host processing devices 106, the at least the first portion of the first computer code 114.

At step 310, based at least in part on the execution of the at least a portion of the first computer code 114, non-host processing device 106a may write first data 118 to a destination buffer of second non-host processing device 106b. At step 312, in response to writing the first data 118 to the destination buffer of second non-host processing device 106b, non-host processing device 106a may send a second trigger 116 to second non-host processing device 106b to cause second non-host processing device 106b to execute second computer code 114.

At step 314, non-host processing device 106a may receive a third trigger 116b from another non-host processing device 106. That non-host processing device 106 may have written second data 118 to a destination buffer of non-host processing device 106a. For example, non-host processing device 106a may receive the third trigger 116b from second non-host processing device 106b (e.g., the same non-host processing device 106 from which the first trigger was received if the first trigger was received from a non-host processing device 106) or from another non-host processing device (e.g., third non-host processing device 106c).

At step 316, in response to the third trigger 116b, non-host processing device 106a may execute at least a second portion of the first computer code 114. In certain embodiments, non-host processing device 106a is configured to receive multiple triggers 116b from one or more other non-host processing devices 106 prior to executing the at least a second portion of the first computer code 114. In such an example, non-host processing device 106a may receive the multiple triggers 116b from the one or more other non-host processing devices 106, and may execute, in response to the multiple triggers 116b from the one or more other non-host processing devices 106, the at least the second portion of the first computer code 114.

Method 300 may terminate according to a termination condition indicated in the configuration information 112 for non-host processing device 106a. Additionally or alternatively, non-host processing device 106a may receive an interrupt from host processing device 102 to cause non-host processing device 106a to terminate the first execution flow. This disclosure contemplates method 300 terminating in any suitable manner.

FIG. 4 illustrates an example method 400 for control path communication between non-host processing devices, according to certain embodiments. In certain embodiments, some or all of the operations associated with method 400 are performed by a first non-host processing device 106. For purposes of this example, a first non-host processing device is referred to as non-host processing device 106a, a second non-host processing device is referred to as non-host processing device 106b, and a third non-host processing device is referred to as non-host processing device 106c. One or more of the non-host processing devices 106 involved in method 400 could be an accelerator or a compute-capable storage device, in any suitable combination.

At step 402, non-host processing device 106a of computer system 100 receives from host processing device 102 of computer system 100, configuration information 112 for configuring non-host processing device 106a to execute a first execution flow. In certain embodiments, configuration information 112 includes an assignment of a source memory buffer and a destination memory buffer for non-host processing device 106a to which data 118 for non-host processing device 106a may be written and from which data 118 from non-host processing device 106a may be sent, respectively. In certain embodiments, configuration information 112 may include a termination condition for first non-host processing device 106b to terminate the first execution flow.

At step 404, non-host processing device 106a may receive first computer code 114 for execution by non-host processing device 106a. At step 406, non-host processing device 106a may receive a first trigger 116 to execute at least a first portion of the first computer code 114. In certain embodiments, the at least a first portion of the first computer code 114 is an initial portion of the first computer code 114, and the first trigger 116 is received by non-host processing device 106a from host processing device 102 (e.g., as trigger 116a). In certain embodiments, the first trigger 116 is received by non-host processing device 106a from another non-host processing device 106 (e.g., second non-host processing device 106b, as trigger 116b).

At step 408, non-host processing device 106a may determine whether receipt of additional triggers 116 is expected prior to executing a next portion of the first computer code 114. In certain embodiments, non-host processing device 106a is configured to receive multiple triggers 116b from one or more other non-host processing devices 106 prior to executing the at least a first portion of the first computer code 114. In such an example, non-host processing device 106a may receive the multiple triggers 116b from the one or more other non-host processing devices 106, and may execute, in response to the multiple triggers 116b from the one or more other non-host processing devices 106, the at least the first portion of the first computer code 114.

If non-host processing device 106a determines at step 408 that receipt of additional triggers 116b is expected, then method 400 may proceed to step 410 to await additional triggers 116b. If non-host processing device 106a determines at step 408 that receipt of additional triggers 116b is not expected (e.g., only one trigger 116b was expected and/or all expected triggers 116b have been received), then method 400 may proceed to step 412.

At step 412, in response to receiving the expected triggers 116b, non-host processing device 106a may execute the at least a first portion of the first computer code 114. At step 414, based at least in part on the execution of the at least a portion of the first computer code 114, non-host processing device 106a may write first data 118 to respective destination buffers of one or more other non-host processing devices 106 (e.g., second non-host processing device 106b).

At step 416, in response to writing the first data 118 to the respective destination buffers of one or more other non-host processing devices 106 (e.g., second non-host processing device 106b), non-host processing device 106a may send respective second triggers 116b to the one or more other non-host processing devices 106 (e.g., to second non-host processing device 106b) to cause the one or more other non-host processing devices 106 (e.g., second non-host processing device 106b) to execute second computer code 114.

At step 418, non-host processing device 106a may determine whether a termination condition is detected. For example, method 400 may terminate according to a termination condition indicated in configuration information 112 for non-host processing device 106a. Additionally or alternatively, non-host processing device 106a may receive an interrupt from host processing device 102 to cause non-host processing device 106a to terminate the first execution flow. This disclosure contemplate method 400 terminating in any suitable manner.

If non-host processing device 106a determines at step 418 that the termination condition has not been detected, then method 400 may return to step 410 for non-host processing device 106a to await additional triggers 116. If non-host processing device 106a determines at step 418 that the termination condition has been detected, then method 400 may end.

FIG. 5 illustrates an example signaling flow 500 for accelerator-to-accelerator control path signaling, according to certain embodiments. In the illustrated example, signaling flow 500 involves communication between a host processing device 502, a first non-host processing device 504 (Accelerator 1), and a second non-host device 506 (Accelerator 2). Accelerator 1 and Accelerator 2 may be examples of non-host processing devices 106, and the host processing device 502 may be an example of host processing device 102 of FIG. 1. In certain embodiments, host processing device 502 is a CPU. As shown in the legend of FIG. 5, FIG. 5 includes data path communications, shown using a relatively thick line, and control path communications, shown using a relatively thin line. The following describes steps 1-13 of the example signaling flow 500 of FIG. 5.

At step 1, Accelerator 2 receives configuration information and computer code from host processing device 502. The configuration information may be for configuring Accelerator 2 to execute an execution flow. The computer code may include computer code for execution in association with the execution flow. For example, host processing device 502 may enqueue the computer code (e.g., kernels) to be executed on Accelerator 2.

At step 2, Accelerator 1 receives configuration information and computer code from host processing device 502. The configuration information may be for configuring Accelerator 1 to execute an execution flow. The computer code may include computer code for execution in association with the execution flow. For example, host processing device 502 may enqueue the computer code (e.g., kernels) to be executed on Accelerator 1.

At step 3, host processing device 502 allocates and assigns source and destination buffers to Accelerator 2. In certain embodiments, the allocation and assignment of the source and destination buffers by host processing device 502 may be considered part of the receipt of the configuration information by Accelerator 2 from host processing device 502 of step 1. The source and destination buffers could be part of device memory for Accelerator 2. The allocated source and destination buffers could be used in association with execution of some or all of the received computer code (e.g., for kernel execution) or for any other suitable purpose.

At step 4, host processing device 502 allocates and assigns source and destination buffers to Accelerator 1. In certain embodiments, the allocation and assignment of the source and destination buffers by host processing device 502 may be considered part of the receipt of the configuration information by Accelerator 1 from host processing device 502 of step 2. The source and destination buffers could be part of device memory for Accelerator 1. The allocated source and destination buffers could be used in association with execution of some or all of the received computer code (e.g., for kernel execution) or for any other suitable purpose.

At step 5, host processing device 502 may generate a first trigger to cause Accelerator 1 to execute at least a first portion of the computer code, and at step 6, Accelerator 1 receives the first trigger to cause Accelerator 1 to execute at least a first portion of the computer code. In certain embodiments, the first trigger may be implemented as a so-called doorbell. In such an example, the doorbell may be set up as part of the configuration information Accelerator 1 receives from host processing device 502, though the doorbell may be set up in any suitable manner. Continuing with the doorbell example, at step 5, host processing device 502 may write to the doorbell of Accelerator 1 to cause Accelerator 1 to initiate execution of at least a first portion of the computer code, and at step 6, Accelerator 1 may check whether the doorbell has been set, and clear the doorbell in response to confirming the doorbell has been set. The setting of a doorbell could signify availability of data (e.g., in the destination buffer of Accelerator 1).

In certain embodiments, and continuing with the doorbell example, multiple doorbells may be configured for Accelerator 1 for triggering code execution over the course of an execution flow. For example, a first doorbell could be an initial doorbell that operates to trigger the initial start of code execution and additional doorbells could be configured for respective additional stages of code execution over the course of the execution flow. In signaling flow 500, for example, the doorbell that might be used for steps 5 and 6 could be an initial doorbell. In certain embodiments, and in an implementation of an accelerator as a GPU, the accelerator (e.g., Accelerator 1) might use a GPU-designed thread through a control kernel to check the doorbell and/or use the control path processor portion of a communication controller (e.g., a CXL controller) to check and clear the doorbell.

At step 7, in response to the first trigger, Accelerator 1 may execute at least a portion of the computer code. For example, Accelerator 1 may begin kernel execution.

At step 8, as part of executing the computer code, Accelerator 1 may write data to the external destination buffer of Accelerator 2. For example, the execution flow begun at step 7 may begin a data flow associated with the execution flow. In certain embodiments, through the kernel execution of step 7, the kernel may request that a data mover/accelerator kernel start writing data to the external destination buffer of Accelerator 2.

At step 9, in response to writing data to the destination buffer of Accelerator 2, Accelerator 1 may generate a second trigger to Accelerator 2 to cause Accelerator 2 to execute at least a portion of the computer code of Accelerator 2, and at step 10, Accelerator 2 may receive the second trigger to cause Accelerator 2 to execute at least the portion of the computer code of Accelerator 2. As with the first trigger, in certain embodiments, the second trigger may be implemented as a so-called doorbell. In such an example, the doorbell may be set up as part of the configuration information Accelerator 2 receives from host processing device 502, though the doorbell may be set up in any suitable manner. Continuing with the doorbell example, at step 9, Accelerator 1 may write to the doorbell of Accelerator 2 to cause Accelerator 2 to initiate execution of at least a portion of the computer code of Accelerator 2, and at step 10, Accelerator 2 may check whether the doorbell has been set, and clear the doorbell in response to confirming the doorbell has been set. The setting of a doorbell could signify availability of data (e.g., in the destination buffer of Accelerator 2).

In certain embodiments, and continuing with the doorbell example, multiple doorbells may be configured for Accelerator 2 for triggering code execution over the course of an execution flow. For example, an initial doorbell for Accelerator 2 in the illustrated scenario is set by Accelerator 1 and operates to trigger the initial start of code execution by Accelerator 2, and additional doorbells could be configured for respective additional stages of code execution over the course of the execution flow. In certain embodiments, and in an implementation of an accelerator as a GPU, the accelerator (e.g., Accelerator 2) might use a GPU-designed thread through a control kernel to check the doorbell and/or use the control path processor portion of a communication controller (e.g., a CXL controller) to check and clear the doorbell.

At step 11, in response to the second trigger, Accelerator 2 may execute at least a portion of the computer code of Accelerator 2. For example, Accelerator 2 may begin kernel execution.

At step 12, as part of executing the computer code, Accelerator 2 may write data to the external destination buffer of Accelerator 2. For example, the execution flow begun at step 11 may begin a data flow associated with the execution flow. In other words, in the illustrated example, the execution flow of the code (application) includes a data flow that includes Accelerator 2 writing data to the destination buffer of Accelerator 1. In certain embodiments, through the kernel execution of step 11, the kernel may request that a data mover/accelerator kernel start writing data to the external destination buffer of Accelerator 1.

At step 13, in response to writing data to the destination buffer of Accelerator 1, Accelerator 2 may generate a third trigger to Accelerator 1, possibly to cause Accelerator 1 to execute at least a portion of the computer code of Accelerator 1, and at step 10, Accelerator 2 may receive the second trigger to cause Accelerator 2 to execute at least the portion of the computer code of Accelerator 2. As with the first trigger, in certain embodiments, the second trigger may be implemented as a so-called doorbell. In such an example, the doorbell may be set up as part of the configuration information Accelerator 2 receives from host processing device 502, though the doorbell may be set up in any suitable manner. Continuing with the doorbell example, at step 9, Accelerator 1 may write to the doorbell of Accelerator 2 to cause Accelerator 2 to initiate execution of at least a portion of the computer code of Accelerator 2, and at step 10, Accelerator 2 may check whether the doorbell has been set, and clear the doorbell in response to confirming the doorbell has been set.

Of course, signaling flow 500 and the associated execution flow could continue for additional code executions, data exchanges, and associated control communications. The execution flow and/or associated signaling flow 500 may continue until a termination condition is detected. For example, the execution flow and/or associated signaling flow 500 may terminate according to a termination condition indicated in the configuration information for Accelerator 1 and/or Accelerator 2. The termination condition could be a counter defined at the start of the execution flow (e.g., as part of the configuration information) overflowing. Additionally or alternatively, Accelerator 1 and/or Accelerator 2 may receive an interrupt from host processing device 502 to cause Accelerator 1 and/or Accelerator 2 to terminate the execution flow and/or signaling flow 500. This disclosure contemplate the execution flow and/or signaling flow 500 terminating in any suitable manner.

Among other potential advantages, in certain embodiments, signaling flow 500 reduces a number of control path communications between host processing device 502 and Accelerator 1 and between host processing device 502 and Accelerator 2 by facilitating peer-to-peer control path communication between Accelerator 1 and Accelerator 2 relative to a host-centric control path signaling flow. Such control path communications could include status check and command issue operations, such as those signaling flow 500 implements as the first, second, and third trigger commands.

For simplicity, the execution flow described in connection with signaling flow 500 has been described as involving only two accelerators. It should be understood that the signaling flow could extend to additional non-host processing devices, if appropriate. Furthermore, although host processing device 502 initiates the execution flow described in connection with signaling flow 500 by generating a first trigger for Accelerator 1 to begin the data flow, in certain embodiments, multiple triggers may be generated (e.g., by host processing device 502 or another non-host processing device, including one or more of Accelerators 1 or 2) in a way that triggers multiple non-host processing devices to engage in parallel code execution, such as overlapping or otherwise simultaneous code execution.

FIG. 6 illustrates an example signaling flow 600 for accelerator-to-accelerator with compute-capable storage control path signaling, according to certain embodiments. In the illustrated example, signaling flow 600 involves communication between a host processing device 602, a first non-host processing device 604 (Accelerator 1), a second non-host device 606 (Accelerator 2), and compute-capable storage 608. Accelerator 1, Accelerator 2, and compute-capable storage 608 may be examples of non-host processing devices 106, and host processing device 602 may be an example of host processing device 102 of FIG. 1. In certain embodiments, host processing device 602 is a CPU. As shown in the legend of FIG. 6, FIG. 6 includes data path communications, shown using a relatively thick line, and control path communications, shown using a relatively thin line. The following describes steps 1-23 of the example signaling flow 600 of FIG. 6.

At step 1, Accelerator 2 receives configuration information and computer code from host processing device 602. The configuration information may be for configuring Accelerator 2 to execute an execution flow. The computer code may include computer code for execution in association with the execution flow. For example, host processing device 602 may enqueue the computer code (e.g., kernels) to be executed on Accelerator 2.

At step 2, Accelerator 1 receives configuration information and computer code from host processing device 602. The configuration information may be for configuring Accelerator 1 to execute an execution flow. The computer code may include computer code for execution in association with the execution flow. For example, host processing device 602 may enqueue the computer code (e.g., kernels) to be executed on Accelerator 1.

At step 3, compute-capable storage 608 receives configuration information and computer code from host processing device 602. The configuration information may be for configuring compute-capable storage 608 to execute an execution flow. The computer code may include computer code for execution in association with the execution flow. For example, host processing device 602 may enqueue the computer code (e.g., kernels) to be executed on compute-capable storage 608.

At step 4, host processing device 602 allocates and assigns source and destination buffers to Accelerator 2. In certain embodiments, the allocation and assignment of the source and destination buffers by host processing device 602 may be considered part of the receipt of the configuration information by Accelerator 2 from host processing device 602 of step 1. The source and destination buffers could be part of device memory for Accelerator 2. The allocated source and destination buffers could be used in association with execution of some or all of the received computer code (e.g., for kernel execution) or for any other suitable purpose.

At step 5, host processing device 602 allocates and assigns source and destination buffers to Accelerator 1. In certain embodiments, the allocation and assignment of the source and destination buffers by host processing device 602 may be considered part of the receipt of the configuration information by Accelerator 1 from host processing device 602 of step 2. The source and destination buffers could be part of device memory for Accelerator 1. The allocated source and destination buffers could be used in association with execution of some or all of the received computer code (e.g., for kernel execution) or for any other suitable purpose.

At step 6, host processing device 602 allocates and assigns source and destination buffers to compute-capable storage 608. In certain embodiments, the allocation and assignment of the source and destination buffers by host processing device 602 may be considered part of the receipt of the configuration information by compute-capable storage 608 from host processing device 602 of step 3. The source and destination buffers could be part of device memory for compute-capable storage 608. The allocated source and destination buffers could be used in association with execution of some or all of the received computer code (e.g., for kernel execution) or for any other suitable purpose.

At step 7, host processing device 602 may generate a first trigger to cause compute-capable storage 608 to execute at least a first portion of the computer code, and at step 8, compute-capable storage 608 receives the first trigger to cause compute-capable storage 608 to execute at least a first portion of the computer code. In certain embodiments, the first trigger may be implemented as a so-called doorbell. In such an example, the doorbell may be set up as part of the configuration information compute-capable storage 608 receives from host processing device 602, though the doorbell may be set up in any suitable manner. Continuing with the doorbell example, at step 7, host processing device 602 may write to the doorbell of compute-capable storage 608 to cause compute-capable storage 608 to initiate execution of at least a first portion of the computer code, and at step 8, compute-capable storage 608 may check whether the doorbell has been set, and clear the doorbell in response to confirming the doorbell has been set. The setting of a doorbell could signify availability of data (e.g., in the destination buffer of compute-capable storage 608).

In certain embodiments, and continuing with the doorbell example, multiple doorbells may be configured for compute-capable storage 608 for triggering code execution over the course of an execution flow. For example, a first doorbell could be an initial doorbell that operates to trigger the initial start of code execution and additional doorbells could be configured for respective additional stages of code execution over the course of the execution flow. In signaling flow 600, for example, the doorbell that might be used for steps 7 and 8 could be an initial doorbell. In certain embodiments, and in an implementation of an accelerator as compute-capable storage, the compute-capable storage (e.g., compute-capable storage 608) might use a compute-capable-storage-designed thread through a control kernel to check the doorbell and/or use the control path processor portion of a communication controller (e.g., a CXL controller) to check and clear the doorbell.

At step 9, in response to the first trigger, compute-capable storage 608 may execute at least a portion of the computer code. For example, compute-capable storage 608 may begin kernel execution.

At step 10, as part of executing the computer code, compute-capable storage 608 may write data to the external destination buffer of Accelerator 1, and at step 11, as part of executing the computer code, compute-capable storage 608 may write data to the external destination buffer of Accelerator 2. For example, the execution flow begun at step 9 may begin a data flow associated with the execution flow. In certain embodiments, the execution includes a dataflow that may include invoking the kernel of compute-capable storage 608/communication controller to transfer data to the external destination buffers of one or more other non-host processing devices, potentially in parallel. In the illustrated example, compute-capable storage 608/communication controller transfers data at steps 10 and 11 to destination buffers of Accelerator 1 and Accelerator 2, respectively, in parallel.

At step 12, in response to writing data to the destination buffer of Accelerator 1, compute-capable storage 608 may generate a second trigger to Accelerator 1 to cause Accelerator 1 to execute at least a portion of the computer code of Accelerator 1, and at step 13, Accelerator 1 may receive the second trigger to cause Accelerator 1 to execute at least the portion of the computer code of Accelerator 1. As with the first trigger, in certain embodiments, the second trigger may be implemented as a so-called doorbell. In such an example, the doorbell may be set up as part of the configuration information Accelerator 1 receives from host processing device 602, though the doorbell may be set up in any suitable manner. Continuing with the doorbell example, at step 12, compute-capable storage 608 may write to the doorbell of Accelerator 1 to cause Accelerator 1 to initiate execution of at least a portion of the computer code of Accelerator 1, and at step 13, Accelerator 1 may check whether the doorbell has been set, and clear the doorbell in response to confirming the doorbell has been set. The setting of a doorbell could signify availability of data (e.g., in the destination buffer of Accelerator 1).

In certain embodiments, and continuing with the doorbell example, multiple doorbells may be configured for Accelerator 1 for triggering code execution over the course of an execution flow. For example, an initial doorbell for Accelerator 1 in the illustrated scenario is set by compute-capable storage 608 and operates to trigger the initial start of code execution by Accelerator 1, and additional doorbells could be configured for respective additional stages of code execution over the course of the execution flow. In certain embodiments, and in an implementation of an accelerator as a GPU, the accelerator (e.g., Accelerator 1) might use a GPU-designed thread through a control kernel to check the doorbell and/or use the control path processor portion of a communication controller (e.g., a CXL controller) to check and clear the doorbell.

At step 14, in response to the second trigger, Accelerator 1 may execute at least a portion of the computer code of Accelerator 1. For example, Accelerator 1 may begin kernel execution.

At step 15, as part of executing the computer code, Accelerator 1 may write data to the external destination buffer of compute-capable storage 608. For example, the execution flow begun at step 14 may begin a data flow associated with the execution flow. In other words, in the illustrated example, the execution flow of the code (application) includes a data flow that includes Accelerator 1 writing data to the destination buffer of compute-capable storage 608. In certain embodiments, through the kernel execution of step 14, the kernel may request that a data mover/accelerator kernel start writing data to the external destination buffer of compute-capable storage 608.

At step 16, in response to writing data to the destination buffer of compute-capable storage 608, Accelerator 1 may generate a third trigger to compute-capable storage 608, possibly to cause compute-capable storage 608 to execute at least a portion of the computer code of compute-capable storage 608.

Moving back up signaling flow 600, at step 17, in response to writing data to the destination buffer of Accelerator 2, compute-capable storage 608 may generate a fourth trigger to Accelerator 2 to cause Accelerator 2 to execute at least a portion of the computer code of Accelerator 2, and at step 18, Accelerator 2 may receive the fourth trigger to cause Accelerator 2 to execute at least the portion of the computer code of Accelerator 2. As with the first trigger, in certain embodiments, the fourth trigger may be implemented as a so-called doorbell. In such an example, the doorbell may be set up as part of the configuration information Accelerator 2 receives from host processing device 602, though the doorbell may be set up in any suitable manner. Continuing with the doorbell example, at step 17, compute-capable storage 608 may write to the doorbell of Accelerator 2 to cause Accelerator 2 to initiate execution of at least a portion of the computer code of Accelerator 2, and at step 18, Accelerator 2 may check whether the doorbell has been set, and clear the doorbell in response to confirming the doorbell has been set. The setting of a doorbell could signify availability of data (e.g., in the destination buffer of Accelerator 2).

In certain embodiments, and continuing with the doorbell example, multiple doorbells may be configured for Accelerator 2 for triggering code execution over the course of an execution flow. For example, an initial doorbell for Accelerator 2 in the illustrated scenario is set by compute-capable storage 608 and operates to trigger the initial start of code execution by Accelerator 2, and additional doorbells could be configured for respective additional stages of code execution over the course of the execution flow. In certain embodiments, and in an implementation of an accelerator as a GPU, the accelerator (e.g., Accelerator 2) might use a GPU-designed thread through a control kernel to check the doorbell and/or use the control path processor portion of a communication controller (e.g., a CXL controller) to check and clear the doorbell.

At step 19, in response to the fourth trigger, Accelerator 2 may execute at least a portion of the computer code of Accelerator 2. For example, Accelerator 2 may begin kernel execution.

At step 20, as part of executing the computer code, Accelerator 2 may write data to the external destination buffer of compute-capable storage 608. For example, the execution flow begun at step 19 may begin a data flow associated with the execution flow. In other words, in the illustrated example, the execution flow of the code (application) includes a data flow that includes Accelerator 2 writing data to the destination buffer of compute-capable storage 608. In certain embodiments, through the kernel execution of step 19, the kernel may request that a data mover/accelerator kernel start writing data to the external destination buffer of compute-capable storage 608.

At step 21, in response to writing data to the destination buffer of compute-capable storage 608, Accelerator 2 may generate a fifth trigger to compute-capable storage 608, possibly to cause compute-capable storage 608 to execute at least a portion of the computer code of compute-capable storage 608.

At step 22, compute-capable storage 608 may receive the third trigger sent by Accelerator 1 at step 16 and the fifth trigger sent by Accelerator 2 at step 21 to cause compute-capable storage 608 to execute at least the portion of the computer code of compute-capable storage 608. In certain embodiments, compute-capable storage 608 is programmed to await receipt of both the third trigger from Accelerator 1 and the fifth trigger of Accelerator 2 (and possibly other triggers) before executing the portion of the computer code of compute-capable storage 608. As with the first trigger, in certain embodiments, the third and fifth triggers may be implemented as so-called doorbells. In such an example, the doorbells may be set up as part of the configuration information compute-capable storage 608 receives from host processing device 602, though the doorbells may be set up in any suitable manner. Continuing with the doorbell example, at step 16, Accelerator 1 may write to a first doorbell of compute-capable storage 608 and, at step 21, Accelerator 2 may write to a second doorbell of compute-capable storage 608 to cause compute-capable storage 608 to initiate execution of at least a portion of the computer code of compute-capable storage 608, and at step 22, compute-capable storage 608 may check whether the doorbells have been set, and clear the doorbells in response to confirming the doorbells have been set. Additionally or alternatively, a single doorbell might be used that is capable of being “rung” by both Accelerator 1 (at step 16) and Accelerator 2 (at step 21).

At step 23, in response to both the third and fifth triggers, compute-capable storage 608 may execute at least a portion of the computer code of compute-capable storage 608. For example, compute-capable storage 608 may begin kernel execution.

In certain embodiments, steps 12-16 and steps 17-21 are performed at least partially in parallel. For example, compute-capable storage 608 may transmit the second trigger (of step 12) and the fourth trigger (of step 17) in close proximity in time, so that Accelerator 1 and Accelerator 2 can execute code at least partially in parallel. Additionally, the order of at least steps 12-16 and steps 17-21 could be different than as shown.

Of course, signaling flow 600 and the associated execution flow could continue for additional code executions, data exchanges, and associated control communications. The execution flow and/or associated signaling flow 600 may continue until a termination condition is detected. For example, the execution flow and/or associated signaling flow 600 may terminate according to a termination condition indicated in the configuration information for Accelerator 1, Accelerator 2, and/or compute-capable storage 608. The termination condition could be a counter defined at the start of the execution flow (e.g., as part of the configuration information) overflowing. Additionally or alternatively, Accelerator 1, Accelerator 2, and/or compute-capable storage 608 may receive an interrupt from host processing device 602 to cause Accelerator 1, Accelerator 2, and/or compute-capable storage 608 to terminate the execution flow and/or signaling flow 600. This disclosure contemplate the execution flow and/or signaling flow 600 terminating in any suitable manner.

Among other potential advantages, in certain embodiments, signaling flow 600 reduces a number of control path communications between host processing device 602 and Accelerator 1, between host processing device 602 and Accelerator 2, and between host processing device 602 and compute-capable storage 608 by facilitating peer-to-peer control path communication between/among Accelerator 1, Accelerator 2, and/or compute-capable storage 608 relative to a host-centric control path signaling flow. Such control path communications could include status check and command issue operations, such as those signaling flow 600 implements as the first, second, third, fourth, and fifth trigger commands.

For simplicity, the execution flow described in connection with signaling flow 600 has been described as involving only two accelerators and one compute-capable storage. It should be understood that the signaling flow could extend to additional non-host processing devices, if appropriate. Furthermore, although host processing device 602 initiates the execution flow described in connection with signaling flow 600 by generating a first trigger for compute-capable storage 608 to begin the data flow, in certain embodiments, multiple triggers may be generated (e.g., by host processing device 602 or another non-host processing device, including one or more of Accelerators 1 or 2 or compute-capable storage 608) in a way that triggers multiple non-host processing devices to engage in parallel code execution, such as overlapping or otherwise simultaneous code execution.

Methods 300 and 400 and signaling flows 500 and 600 may be combined and performed using the systems and apparatuses described herein. Although shown in a logical order, the arrangement and numbering of the steps of methods 300 and 400 and signaling flows 500 and 600 are not intended to be limited. The steps of methods 300 and 400 and signaling flows 500 and 600 may be performed in any suitable order or concurrently with one another as may be apparent to a person of skill in the art.

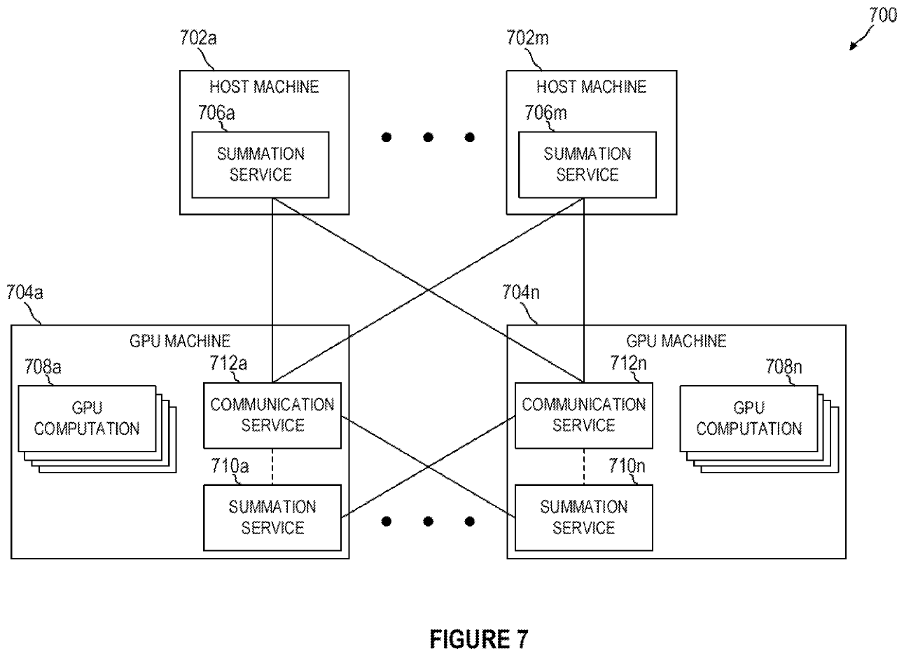

FIG. 7 illustrates an example computing environment 700 in which certain embodiments of this disclosure may be implemented. In particular, computing environment 700 may be used for machine learning applications. For example, computing environment 700 may be used to implement a multi-node GPU system for large scale machine learning training. In such an example environment, a parameter server approach may be used due to the large size of the machine learning model(s). It should be understood that the machine learning application is just one example application of certain concepts associated with this disclosure.

Computing environment 700 includes host machines 702a through 702m, which may be referred to generally as host machines 702 and GPU machines 704a-704n, which may be referred to generally as GPU machines 704. In the illustrated example, host machines 702a through 702m, which may be implemented as CPUs, include respective summation services 706. For example, host machine 702a includes summation service 706a, and host machine 702m includes summation service 706m. Additionally, in the illustrated example, GPU machines 704a through 704n include respective GPU computation processes 708, summation services 710, and communication services 712. For example, GPU machine 704a includes GPU computation processes 708a, summation service 710a, and communication service 712a, and GPU machine 704n includes GPU computation processes 708n, summation service 710n, and communication service 712n.

In an example implementation of computing environment 700 for machine learning, with machine learning training, multiple GPUs (e.g., GPU machines 704a through 704n) may be used to train a model, particularly as the size of the mode increases. One approach to aggregate models across different GPUs is a so-called parameter server. In such an example, a model may be implemented on different GPU machines 704, and each GPU machine 704 may train that model with different training data or under other varying circumstances. After training the GPU machines 704 may report the training results to one synchronized location of storage (the parameter server, which may be implemented using a compute-capable storage device). After the parameter server performs an aggregation, the aggregation may be broadcast back to the GPU machines 704 to continue training the corresponding models. In such an example, each host machine 702 may be considered a parameter server.

In certain embodiments, computing environment 700 could be an example environment for a signaling flow similar to signaling flows 500 or 600. For example, host machines 702 may act as a compute-capable storage device. Each GPU machine 704 may train a model using a set of training data, write data to a destination buffer of the host machine 702 as a result of the training, and send a trigger to a host machine 702 (rings a doorbell of the host machine 702) after the data is written to the destination buffer of the host machine 702. The host machine 702 may be programmed to wait for a trigger from each of a set of GPU machines 704 before performing an aggregation operation, which may be the portion of the computer code executed by the GPU machines in response to the expected triggers. Once a host machine 702 receives all of the expected triggers from corresponding GPU machines 704, the host machine 702 may perform the aggregation operation on the data and write certain data to the various destination buffers of the GPU machines 704. After writing the data to the destination buffers, the host machine 702 may send a trigger to the respective GPU machines 704 to cause the GPU machines 704 to perform updated training. This cycle may be iterated as many times as desired.

According to certain embodiments of this disclosure, GPU machines 704 and host machines 702 may communicate with one another in a P2P manner, using interconnects such as CXL that have increased bandwidth relative to certain conventional systems. This may improve an ability of certain machine learning systems to scale, potentially improving performance, such as allowing such a system to use over an increased number of GPUs (e.g., up to 8 or more), which may allow machine learning to be executed more efficiently.

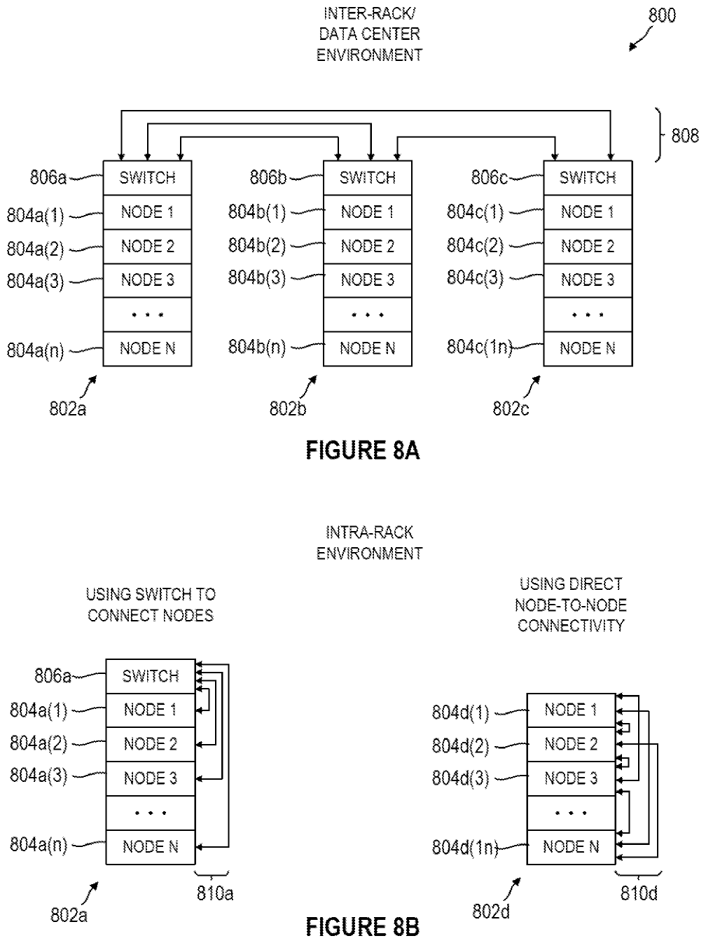

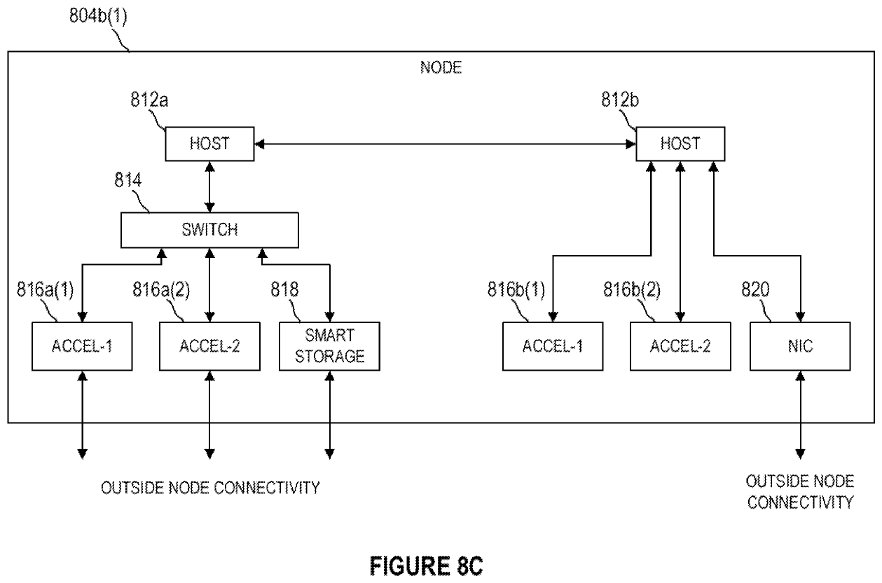

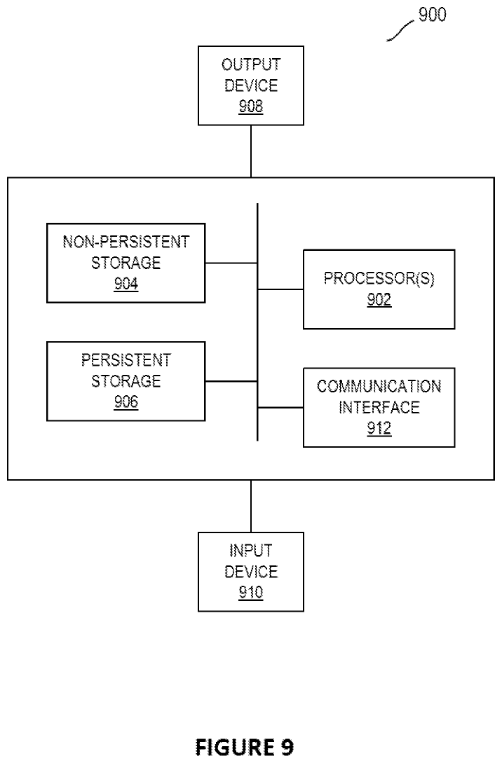

FIGS. 8A-8C illustrate various levels of an example computing environment 800 in which aspects of this disclosure may be implemented, according to certain embodiments. In particular, FIG. 8A illustrates an example inter-rack data center environment, FIG. 8B illustrates an example intra-rack environment, and FIG. 8C illustrates a particular node.

As illustrated in FIG. 8A, computing environment 800, which may correspond to a data center for example, includes multiple racks 802a, 802b, and 802c, which may be referred to generally as racks 802. Although three racks 802 are shown, computing environment 800 may include any suitable number of racks 802. Each rack 802 includes multiple nodes 804(1)-804(n) and a switch 806. For example, rack 802a includes nodes 804a(1) through 804a(n) and switch 806a, rack 802b includes nodes 804b(1) through 804b(n) and switch 806b, and rack 802c includes nodes 804c(1) through 804c(n) and switch 806c. Although each rack 802 is shown to include n nodes, that number of nodes 804 could vary between racks 802. Furthermore, one or more racks 802 could include multiple switches 806, if appropriate.

Each node 804 may include any suitable type of processing device, such as a server computer as just one example. Racks 802 may be configured to communicate via one or more links 808. Links 808 may implement rack-to-rack communication, such that each rack 802 is communicatively couple to each other rack 802. Switches 806 may facilitate communication via links 808.

As illustrated in FIG. 8B, using rack 802a of FIG. 8a and a new racks 802d as examples, nodes 804 of racks 802 may be configured to communicate intra-rack in different ways. As shown with rack 802a of FIG. 8B, nodes 804a(1) through 804(a) (n) may communicate using switch 806a. In other words, each node 804a may be communicatively coupled to switch 806a using one or more links 810a, and may use those links 810a to communicate with other nodes 804a via switch 806. As shown with rack 802d of FIG. 8B, nodes 804a(1) through 804(a) (n) may be communicatively coupled to one another using one or more links 810d, and may use those links 810d to communicate directly with other nodes 804d.

FIG. 8C illustrates example details of a particular node 804, using node 804b(1) as an example. Aspects of example node 804b(1) are described in greater detail below.

Node 804b(1) includes multiple host processing devices 812 (host processing device 812a and host processing device 812b), which may be communicatively coupled to one another. In certain embodiments, host processing devices 812 may be CPUs. Host processing device 812a is coupled to switch 814. Switch 814 is communicatively coupled to a first accelerator 816a(1) (Accel-1), a second accelerator 816a(2) (Accel-2), and a compute-capable storage device 818 (smart storage). Host processing device 812b is communicatively coupled to a first accelerator 816b(1) (Accel-1), a second accelerator 816b(2), and a network interface card (NIC) 820, which could, in certain implementations, be a compute-capable NIC.

Accelerator 816a(1), accelerator 816a(2), compute-capable storage device 818, accelerator 816b(1), and accelerator 816b(2) may be examples of non-host processing devices 106 of FIG. 1, and host processing devices 812a and 812b may be examples of host processing device 102 of FIG. 1.

FIG. 9 illustrates a block diagram of an example computing device 900, according to certain embodiments. As discussed above, embodiments of this disclosure may be implemented using computing devices. For example, all or any portion of the components shown in FIGS. 1-3 and 6-8, and 9A-9C may be implemented, at least in part, using one or more computing devices. As another example, all or any portion of the methods shown in FIGS. 4-5 and signaling flows shown in FIGS. 6-7 may be implemented, at least in part, using one or more computing devices such as computing device 900.

Computing device 900 may include one or more computer processors 902, non-persistent storage 904 (e.g., volatile memory, such as random access memory (RAM), cache memory, etc.), persistent storage 906 (e.g., a hard disk, an optical drive such as a compact disk (CD) drive or digital versatile disk (DVD) drive, a flash memory, etc.), a communication interface 912 (e.g., Bluetooth interface, infrared interface, network interface, optical interface, etc.), input devices 910, output devices 908, and numerous other elements and functionalities. Each of these components is described below.

In certain embodiments, computer processor(s) 902 may be an integrated circuit for processing instructions. For example, computer processor(s) may be one or more cores or micro-cores of a processor. Processor 902 may be a general-purpose processor configured to execute program code included in software executing on computing device 900. Processor 902 may be a special purpose processor where certain instructions are incorporated into the processor design. Although only one processor 902 is shown in FIG. 9, computing device 900 may include any number of processors.

Computing device 900 may also include one or more input devices 910, such as a touchscreen, keyboard, mouse, microphone, touchpad, electronic pen, motion sensor, or any other type of input device. Input devices 910 may allow a user to interact with computing device 900. In certain embodiments, computing device 900 may include one or more output devices 908, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to computer processor(s) 902, non-persistent storage 904, and persistent storage 906. Many different types of computing devices exist, and the aforementioned input and output device(s) may take other forms. In some instances, multimodal systems can allow a user to provide multiple types of input/output to communicate with computing device 900.

Further, communication interface 912 may facilitate connecting computing device 900 to a network (e.g., a LAN, WAN) such as the Internet, mobile network, or any other type of network) and/or to another device, such as another computing device. Communication interface 912 may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a Bluetooth® Low Energy (BLE) wireless signal transfer, an IBEACON® wireless signal transfer, an RFID wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 912 may also include one or more Global Navigation Satellite System (GNSS) receivers or transceivers that are used to determine a location of the computing device 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

All or any portion of the components of computing device 900 may be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Certain embodiments may provide none, some, or all of the following technical advantages. These and other potential technical advantages may be described elsewhere in this disclosure, or may otherwise be readily apparent to those skilled in the art based on this disclosure.

Certain embodiments may provide an optimized control path for non-host-processing-device-to/from-non-host-processing-device (e.g., accelerator-to/from-accelerator, accelerator-to/from-compute-capable-storage, and/or compute-capable-storage-to-compute-capable storage transfers) in an execution flow in a manner that reduces control path communication with the host processing device during the execution flow. Certain embodiments of this application provide a non-host-based control path, controlled by accelerator or storage, that may improve communication performance and/or latency, and that may improve QoS for application execution. A communication scheme that reduces control path communications through the host processing device may reduce a burden on the host processing device, potentially freeing host processing device processing resources for other tasks for which the host processing device is responsible. Due to the communication control path built into the accelerator or storage kernel/controller, a need for an explicit memory copy in a host might be reduced or eliminated, potentially providing easier programmability. Certain embodiments may reduce or eliminate choke blocks for scalability. Certain embodiments may provide improved system resilience. Certain embodiments may be accelerator/storage vendor-agnostic, providing easier programming with many accelerators and storage modules. Although usable in any of a variety of contexts, from simple computer system setups to complex computing environments, certain embodiments may be useful for large algorithm processing scenarios, such as ML training.

It should be understood that the systems and methods described in this disclosure may be combined in any suitable manner.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A computer-implemented method, comprising:
receiving, by a first non-host processing device of a computer system from a host processing device of the computer system, configuration information for configuring the first non-host processing device to execute a first execution flow;
receiving, by the first non-host processing device, first computer code for execution by the first non-host processing device;
receiving, by the first non-host processing device, a first trigger to execute at least a first portion of the first computer code;
executing, by the first non-host processing device and in response to the first trigger, the at least a first portion of the first computer code;
writing, by the first non-host processing device and based at least in part on the execution of the at least a first portion of the first computer code, first data to a destination buffer of a second non-host processing device; and
sending, by the first non-host processing device and in response to writing the first data to the destination buffer of the second non-host processing device, a second trigger to the second non-host processing device to cause the second non-host processing device to execute second computer code.

2. The computer-implemented method of claim 1, wherein:
the at least a first portion of the first computer code is an initial portion of the first computer code; and
the first trigger is received by the first non-host processing device from the host processing device.

3. The computer-implemented method of claim 1, wherein the first trigger is received by the first non-host processing device from another non-host processing device.

4. The computer-implemented method of claim 1, further comprising:
receiving, by the first non-host processing device, a third trigger from a third non-host processing device, wherein the third non-host processing device has written second data to a destination buffer of the first non-host processing device; and
executing, by the first non-host processing device in response to the third trigger, at least a second portion of the first computer code.

5. The computer-implemented method of claim 4, wherein the second non-host processing device and the third non-host processing device are a same non-host processing device.

6. The computer-implemented method of claim 1, wherein:
the first non-host processing device is configured to receive multiple triggers from one or more other non-host processing devices prior to executing at least a second portion of the first computer code; and
the method further comprises:
receiving, by the first non-host processing device, the multiple triggers from the one or more other non-host processing devices; and
executing, by the first non-host processing device in response to the multiple triggers from the one or more other non-host processing devices, the at least the second portion of the first computer code.

7. The computer-implemented method of claim 1, wherein:
at least one of the first non-host processing device or the second non-host processing device is an accelerator;
at least one of the first non-host processing device or the second non-host processing device is a compute-capable storage device; or
one of the first non-host processing device and second non-host processing devices is an accelerator and the other of the first non-host processing device and the second non-host processing device is a compute-capable storage device.

8. The computer-implemented method of claim 1, wherein the configuration information comprises an assignment of a source memory buffer and a destination memory buffer.

9. The computer-implemented method of claim 1, wherein:
the configuration information comprises a termination condition for terminating, by the first non-host processing device, the first execution flow; or
the method further comprises receiving, by the first non-host processing device, an interrupt from the host processing device to cause the first non-host processing device to terminate the first execution flow.

10. A first non-host processing device, comprising:
a trigger processing engine configured to send and receive triggers;
one or more processors; and
one or more non-transitory computer-readable storage media storing programming for execution by the one or more processors, the programming comprising instructions to:
receive, from a host processing device of a computer system,
configuration information for configuring the first non-host processing device to execute a first execution flow;
receive first computer code for execution by the first non-host processing device;
execute, in response to a first trigger received via the trigger processing engine, at least a first portion of the first computer code;
write, based at least in part on the execution of the at least a first portion of the first computer code, first data to a destination buffer of a second non-host processing device; and
send, in response to writing the first data to the destination buffer of the second non-host processing device and via the trigger processing engine, a second trigger to the second non-host processing device to cause the second non-host processing device to execute second computer code.

11. The first non-host processing device of claim 10, wherein:
the at least a first portion of the first computer code is an initial portion of the first computer code; and
the first trigger is received from the host processing device.

12. The first non-host processing device of claim 10, wherein the first trigger is received from another non-host processing device.

13. The first non-host processing device of claim 10, wherein the programming further comprises instructions to execute, in response to a third trigger received via the trigger processing engine, at least a second portion of the first computer code, the third trigger received from a third non-host processing device that has written second data to a destination buffer of the first non-hose processing device.

14. The first non-host processing device of claim 13, wherein the second non-host processing device and the third non-host processing device are a same non-host processing device.

15. The first non-host processing device of claim 10, wherein:
the first non-host processing device is configured to receive multiple triggers from one or more other non-host processing devices prior to executing at least a second portion of the first computer code; and
the programming further comprises instructions to:
receive the multiple triggers from the one or more other non-host processing devices; and
execute, in response to the multiple triggers from the one or more other non-host processing devices, the at least the second portion of the first computer code.

16. The first non-host processing device of claim 10, wherein:
at least one of the first non-host processing device or the second non-host processing device is an accelerator;
at least one of the first non-host processing device or the second non-host processing device is a compute-capable storage device; or
one of the first non-host processing device and second non-host processing devices is an accelerator and the other of the first non-host processing device and the second non-host processing device is a compute-capable storage device.

17. The first non-host processing device of claim 10, wherein the configuration information comprises an assignment of a source memory buffer and a destination memory buffer.

18. The first non-host processing device of claim 10, wherein:
the configuration information comprises a termination condition for terminating, by the first non-host processing device, the first execution flow; or
the programming further comprises instructions to receive an interrupt from the host processing device to cause the first non-host processing device to terminate the first execution flow.

19. One or more non-transitory computer-readable storage media storing programming for execution by one or more processors, the programming comprising instructions to:
receive, by a first non-host processing device of a computer system from a host processing device of the computer system, configuration information for configuring the first non-host processing device to execute a first execution flow;
receive, by the first non-host processing device, first computer code for execution by the first non-host processing device;
receive, by the first non-host processing device, a first trigger to execute at least a first portion of the first computer code;
execute, by the first non-host processing device and in response to the first trigger, the at least a first portion of the first computer code;
write, by the first non-host processing device and based at least in part on the execution of the at least a first portion of the first computer code, first data to a destination buffer of a second non-host processing device; and
send, by the first non-host processing device and in response to writing the first data to the destination buffer of the second non-host processing device, a second trigger to the second non-host processing device to cause the second non-host processing device to execute second computer code.

20. The one or more non-transitory computer-readable storage media of claim 19, wherein:
the first non-host processing device is configured to receive multiple triggers from one or more other non-host processing devices prior to executing at least a second portion of the first computer code; and
the programming further comprises instructions to:
receiving, by the first non-host processing device, the multiple triggers from the one or more other non-host processing devices; and
executing, by the first non-host processing device in response to the multiple triggers from the one or more other non-host processing devices, the at least the second portion of the first computer code.
